(19) United States
(12) Patent Application Publication
(10) Pub. No.: US 2023/0255412 A1
(43) Pub. Date: Aug. 17, 2023

(54) REDUCED LOSS OF PRIME FOAM AT-A-DISTANCE DISPENSER SYSTEMS

(71) Applicant: GOJO Industries, Inc., Akron, OH (US)

(72) Inventors: Nick E. Ciavarella, Seven Hills, OH (US); Jeffrey S. Louis, Akron, OH (US)

(21) Appl. No.: 18/163,973

(22) Filed: Feb. 3, 2023

Related U.S. Application Data
(60) Provisional application No. 63/311,255, filed on Feb. 17, 2022.

(51) Int. Cl. A47K 5/16; B01F 23/20; B01F 35/71

(52) U.S. Cl. CPC A47K 5/16; B01F 23/291; B01F 35/7176; B01F 35/71805; B01F 2101/4505

(57) ABSTRACT

An exemplary foam-at-a-distance soap or sanitizer dispenser includes a housing, a container for holding a foamable liquid, and a pump in fluid communication with the container. The pump has a pump chamber air inlet, a pump chamber air inlet valve, a pump chamber air outlet, a pump chamber air outlet valve, a pump chamber liquid inlet, a liquid chamber liquid inlet valve, a pump chamber liquid outlet, and a pump chamber liquid outlet valve. The exemplary dispenser further includes an air conduit extending from the pump chamber air outlet to a remote mixing chamber and a liquid conduit extending from the pump chamber liquid outlet to the remote mixing chamber. The remote mixing chamber is located at a distance from the pump chamber air outlet valve and the pump chamber liquid outlet valve and that distance is greater than about 3 inches. A one-way liquid check valve is located proximate the mixing chamber, one or more mix media located downstream of the mixing chamber and an outlet nozzle located proximate the mixing chamber.

### CROSS-REFERENCE TO RELATED APPLICATION(S)

This application claims priority to and the benefit of U.S. Provisional Pat. Application No. 63/311,255, filed Feb. 17, 2022, the entire disclosure of which is incorporated herein by reference in full.

### TECHNICAL FIELD

The present invention relates generally to pumps and dispenser systems, and more particularly to foam at-a-distance dispensing systems that have a pump-to-pump liquid (e.g. sanitizer) and air an mix them together at a location away from the pump to create and dispense a foam-at-a-distance product.

### BACKGROUND OF THE INVENTION

Liquid dispenser systems, such as liquid soap and sanitizer dispensers, provide a user with a predetermined amount of liquid upon actuation of the dispenser. Sometimes the liquid is mixed with air and dispensed as a foam. Typically, the liquid and air are mixed together near the pump and the foam product is directly dispensed to a user. In some instances, the liquid and air are mixed together by the pump and pushed through a dispensing tube and dispensed at a location away from the foam pump. Often there are quality issues with the foam, particularly when the dispenser has been stationary for a period of time and the residual foam in the tube breaks down and turns into a liquid that settles at the bottom of tube. When this happens, a burst of liquid is dispensed prior to foam being dispensed on the subsequent dispense.

There have been attempts to mix liquid and air at a location away from the pump, however, the consistency of the foam output in those systems is often poor. It is believed that the inconsistency in these prior art systems is at least partially due to inconsistent mixture ratios created by the air flow through the air dispensing tube and the liquid flow through the liquid dispensing tube. In addition, loss of prime often occurs overnight, over the weekend, or generally when the dispensers are not used for an extended period of time when the liquid in the liquid dispense tube evaporates. This issue is particularly exuberated in dispensers that dispense foamed alcohol for sanitizing hands.

### SUMMARY

The present application discloses exemplary foam-at-a-distance soap or sanitizer dispensers. An exemplary foam-at-a-distance soap or sanitizer dispenser includes a housing, a container for holding a foamable liquid, and a pump in fluid communication with the container. The pump has one or more air pump chambers, a pump chamber air inlet, a pump chamber air inlet valve, a pump chamber air outlet, a liquid pump chamber, a pump chamber liquid inlet, a liquid inlet valve, a pump chamber liquid outlet, and a pump chamber liquid outlet valve. The exemplary dispenser further includes an air conduit extending from the air pump chamber air outlet to a remote mixing chamber and a liquid conduit extending from the liquid pump chamber liquid outlet to the remote mixing chamber. The remote mixing chamber is located at a distance from the air pump chamber air outlet valve and the liquid pump chamber liquid outlet valve and that distance is greater than about 3 inches. A one-way liquid check valve is located proximate the mixing chamber and one or more mix media located downstream of the mixing chamber and an outlet nozzle located proximate the mixing chamber.

An exemplary foam-at-a-distance counter mount soap or sanitizer dispenser includes a spout configured to be mounted above a counter top, an outlet nozzle located in the spout, a mixing chamber located in the spout proximate the outlet nozzle. Also included is a mixing chamber air inlet, a mixing chamber liquid inlet. A one-way valve is located upstream of, and proximate to, the mixing chamber liquid inlet. A pump, configured to be located below a counter top, is also included in the foam-at-a-distance counter mount dispenser. The pump has an air pump chamber, an air inlet, an air inlet valve, an air outlet, an air outlet valve, a liquid pump chamber, a liquid inlet, a liquid inlet valve, a liquid outlet, and a liquid outlet valve. An air conduit extends from the pump air outlet to a remote mixing chamber. A liquid conduit extends from the pump liquid outlet to the one-way valve. The dispenser further includes a reservoir configured to be located below the counter top and a liquid inlet conduit that extends from the reservoir to the pump liquid inlet.

Another exemplary foam-at-a-distance table top soap or sanitizer dispenser includes a base, and a housing extending upward from the base. A pump is located in the base. The housing has a cantilevered portion extending outward the housing. An outlet nozzle is located in the cantilevered portion. A removable and replaceable reservoir is carried by the housing. A remote mixing chamber is located by the outlet nozzle. The remote mixing chamber is located at least 3 inches from the pump. The mixing chamber has an air inlet, a liquid inlet and a fluid outlet. A one-way liquid inlet valve is located proximate the liquid inlet. An air conduit extending from the pump to the mixing chamber air inlet and a liquid conduit extending from the pump to the liquid inlet, wherein the one-way liquid inlet valve is located in a fluid flow path from the pump to the mixing chamber liquid inlet. In addition, a centerline of the air inlet and a centerline of the liquid inlet to the mixing chamber intersect at an angle of less than 90 degrees.

### BRIEF DESCRIPTION OF THE DRAWINGS

FIG. 1 is a prospective view of an exemplary embodiment of a foam-at-a-distance dispensing system having a remote mixing chamber and foam outlet that is located away from the pump;

FIG. 2 is a partial cross-section of the foam-at-a-distance dispenser of FIG. 1 having an inverted container;

FIG. 3 is a prospective view of selected components of the foam-at-a-distance dispenser of FIG. 1;

FIG. 4 is an exploded view of an exemplary embodiment of a remote mixing chamber having a reduced loss of prime for a foam-at-a-distance dispenser;

FIG. 5 is a prospective view of selected components of a foam-at-a-distance dispenser having an upright container; and

FIG. 6 is an exemplary embodiment of a counter mount foam-at-a-distance dispenser.

FIG. 7 is an exemplary embodiment of a remote mixing chamber illustrating fluid flow angles into the remote mixing chamber.

### DETAILED DESCRIPTION

The present application discloses exemplary embodiments of foam dispensers and dispensing systems. The foam dispenser may include a sequentially activated multi-diaphragm pumps. The dispensers produce foam at a location that is remote from the pump(s).

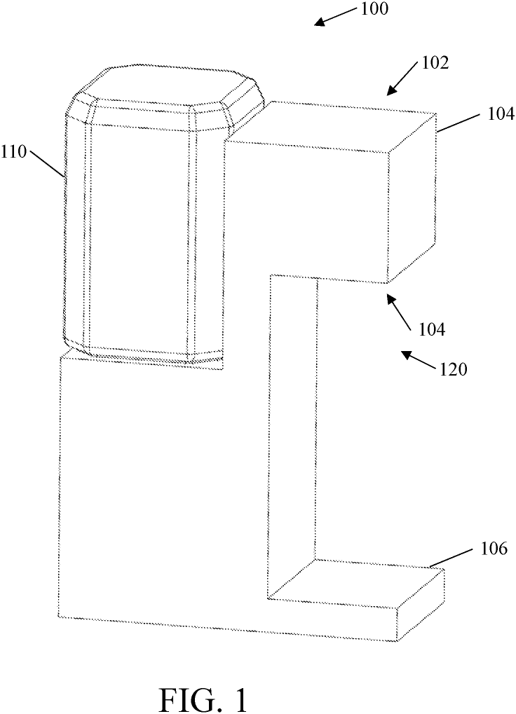

FIG. 1 is an exemplary embodiment of a foam-at-a-distance dispenser 100. In this exemplary embodiment, the dispenser 100 is a table top dispenser. In some embodiments, the dispenser is an under counter mount dispenser with a dispensing outlet located above the counter. In some embodiments, the dispenser is a wall mounted dispenser. Foam-at-a-distance dispenser 100 includes a housing 102. Housing 102 includes an upper portion 104 that contains an outlet nozzle 130 for dispensing a foam product, such as, for example, foam sanitizer. Housing 102 also includes a base 106.

Dispenser 100 includes electrical components (not shown) that are required for operating dispenser 100 in a touch-free manner. The electrical components include: one or more power sources, such as, for example, one or more batteries; a microprocessor; a sensor for sensing an object proximate the outlet nozzle; circuitry for activating a pump; logic for causing the processor to control the functions of the dispenser 100; indicating lights; and any other circuitry required to perform the functions described herein or necessary for operation of a dispenser. Some exemplary touch-free dispenser components that may be used in accordance with the present invention are shown and described in U.S. Pat. No, 8,960,498 titled Touch-Free Dispenser With Single Cell Operation And Battery Banking; U.S. Pat. Pub. No. 2014/00543.22 titled Off-Axis Inverted Foam Dispensers And Refill Units and Pub. No. 2014/0234140 titled Power Systems For Touch Free Dispensers And Refill Units Containing a Power Source, which are incorporated herein by reference in their entirety.

In this exemplary embodiment, base 106 may include a recessed portion (not shown) that is configured to catch and retain any residual product that drips out of outlet 130. Located between upper housing portion 104 and base 106 is a hand sensing region 120. A sensor (not shown), such as, for example, an infrared emitter/detector is configured to sense a user’s hand entering the sensing region, and cause dispenser 100 to dispense a dose of foam product.

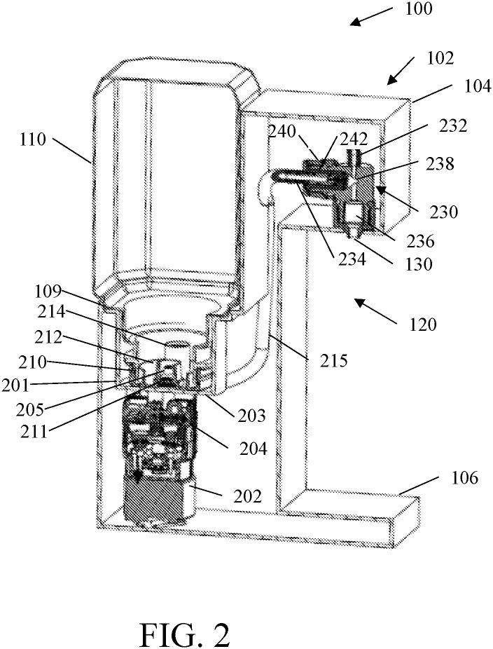

FIG. 2 is a cross-section of dispenser 100. As can be seen in FIG. 2, dispenser 100 includes a motor 202 that drives a pump 204. In some embodiment, pump 204 is a sequentially operated multi-diaphragm foam pump. An exemplary sequentially operated multi-diaphragm pump that may be used and/or modified to work herein are shown and described in U.S. Pat. No. 10,912,426, titled Sequentially Activated Multi--Diaphragm Foam Pumps, Refill Units and Dispenser Systems and U.S. Pat. No. 10,143,339, titled Sequentially Activated Multi--Diaphragm Foam Pumps, Refill Units and Dispenser Systems. Both of which are incorporated herein by reference in their entirety. Many of the incorporated pumps above, would need to be modified to separate the liquid outlet and the air outlet so that the liquid and air may be separately pumped to the remote mixing chamber.

The exemplary single sequentially activated multi-diaphragm pump pumps liquid and air through separate conduits to a remote mixing chamber where the liquid and air are mixed together. In some embodiments, two separate pumps may be used, one to pump liquid and one to pump air.

Housing 102 includes a receptacle 109 for receiving and holding a refill container 110. Receptacle 109 includes a recessed portion 201 having a floor 203. A liquid inlet conduit 205 extends up from the floor 203. When container 110 and its closure 210 are placed in the receptacle 109, the upper portion of liquid inlet conduit (or post) 205 pushes through a resealable member 211 to place the pump 204 in fluid communication with the interior of container 110. In this exemplary embodiment, container 110 is a non-collapsible container and a container vent 214 is included to allow air to be drawn into the container 110 once sufficient vacuum pressure is reached inside of container 110.

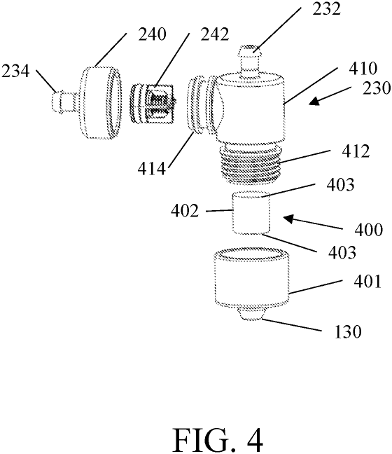

An exemplary refill unit, receptacle and connection system is shown and described in Applicant’s Patent No. 11,246,457 titled Double Inlet Valve for Enhanced Pump Efficiency, which is incorporated herein in its entirety. FIGS. 4-8 and the description thereof provide a detailed description of these components.

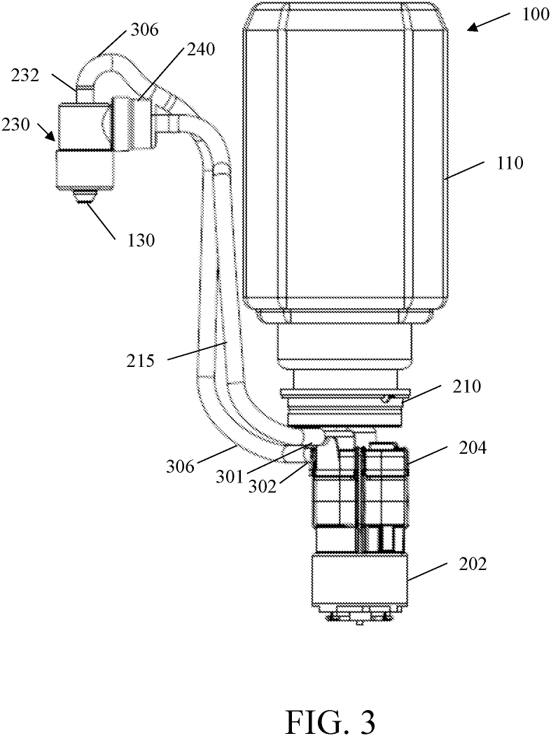

Pump 204 includes one or more an air inlets (not shown). The liquid outlet of pump 204 is connected to a liquid outlet conduit 215 and the air outlet of pump 204 is connected to air outlet conduit 306, which is best illustrated in FIG. 3. The liquid outlet conduit 215 and air outlet conduit 306 connect to remote foaming member 230. The term “remote” as used herein means that the mixing chamber 238 of remote foaming member 230 is located at least 3″ from the air outlet 302 and liquid outlet 301 of the pump 204.

As shown in FIG. 2 and the exploded view in FIG. 4, remote foaming member 230 includes a mixing chamber housing 410. Mixing chamber housing includes an air inlet 232. Mixing chamber housing 410 also includes a liquid inlet cap connector 414. Liquid inlet cap connector 414 connects to liquid inlet cap 240. A liquid inlet 234 is included in liquid inlet cap 240. Liquid inlet cap 240 securely connects to remote mixing chamber housing 410. A one-way liquid inlet valve 242 is placed in the liquid inlet path and retained in place by the liquid inlet cap. Liquid inlet valve 242 is placed proximate the mixing chamber located in mixing chamber housing 410.

Mixing chamber housing 410 also includes a connector 412 that connects to outlet nozzle 401. Outlet nozzle 401 includes a dispensing outlet 130. An optional mixing cartridge 400 is included in the fluid outlet path. The exemplary optional mixing cartridge 400 includes a cylindrical housing 402 that has a screen 403 on either end. The mixing cartridge 400 is retained in the fluid outlet path by outlet nozzle 401 when outlet nozzle 401 is secured to mixing chamber housing 410.

One-way liquid inlet valve 242 is located proximate mixing chamber 238. As used herein, the term proximate means very near or close, which has its ordinary meaning Further, as used herein, proximate should be construed to preferably mean adjacent or next to. Preferably proximate means less than about 2 inches and more preferably, less than about 1 inch.

The one-way liquid inlet valve should be located as close as possible to the mixing chamber 238. One-way liquid inlet valve 242 may be a ball and spring valve, a gravity ball valve, an umbrella ball valve, a poppet valve, duckbill vavle, or the like. It has been discovered that the one-way liquid inlet valve 242 reduces loss of prime that occures, particulaly in alcohol based soap and sanitizer products, when a dispenser sits for a period of time, such as, for example, over night, over the weekend, over holidays, in low use dispensers and the like. While in some embodiments, the one-way liquid inlet valve 242 may be located away from the mixing chamber 238, it has been found that the closer the liquid inlet valve 242 is to the mixing chamber 238 the better the performance.

In this exemplary embodiment, the liquid flow path is substantially perpendicular to the air flow path. In some embodiments, a better quality of foam is achieved by introducing liquid into the air flow at an angled orientation that is greater than 15 degrees. In some embodiments, a better quality of foam is achieved by introducing liquid into the air flow at an angled orientation that is greater than 30 degrees. In some embodiments, a better quality of foam is achieved by introducing liquid into the air flow at an angled orientation that is greater than 45 degrees. In some embodiments, a better quality of foam is achieved by introducing liquid into the air flow at an angled orientation that is greater than 60 degrees. In some embodiments, a better quality of foam is achieved by introducing liquid into the air flow at an angled orientation that is greater than 75 degrees. In some embodiments, a better quality of foam is achieved by introducing liquid into the air flow at an angled orientation that is at about 90 degrees.

In some embodiments, a one-way air inlet valve (not shown) is included in the air inlet line. The one-way air inlet valve (not shown) may prevent residual liquid from flowing down into the air conduit 306 (particularly in configurations where the air inlet 232 of the remote mixing chamber is closer to the liquid inlet and/or entering at the same orientation).

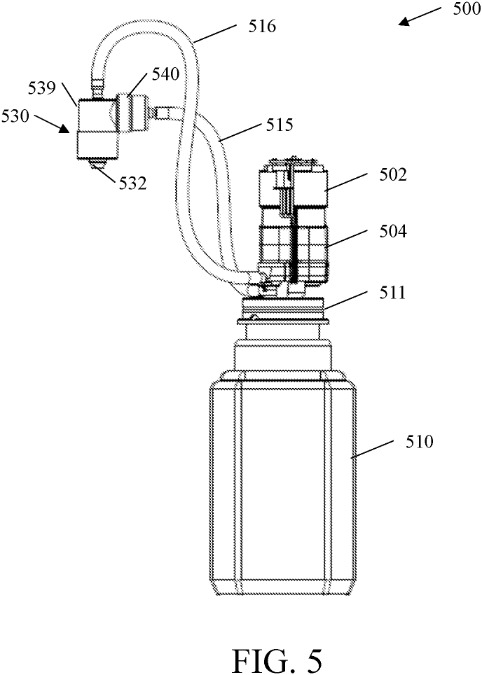

FIG. 5 is a prospective view of selected components of a foam at a distance dispenser 500. In this exemplary embodiment, container 510 is an upright container, as opposed to the inverted container of dispenser 100. Dispenser 500 includes a motor 502, a pump 504. Pump 504 is connected to container 510 through closure 511. A liquid inlet conduit (not shown) is connected to a dip tube (not shown) that extends to the bottom of container 510. An air outlet conduit 516 and a liquid outlet conduit 515 place pump 504 in fluid communication with remote foaming member 530. Remote foaming member 530 is substantially similar to remote foaming member 230. Remote foaming member has a foam product dispensing nozzle 532. A one-way liquid inlet valve (not shown) is located within liquid inlet cap 540 and proximate the remot mixing chamber housing 539.

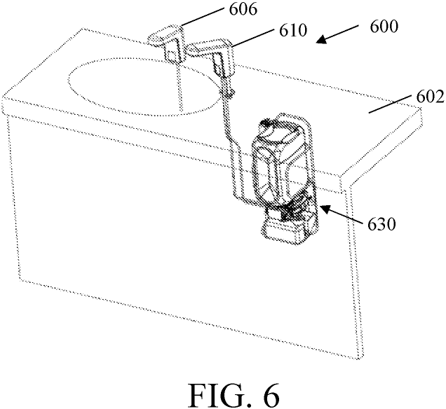

FIG. 6 is an exemplary embodiment of a foam-at-a-distance dispenser 600. Foam at a distance dispenser 600 is an under-counter mount dispensing system having a dispensing spout 610 mounted to the counter top 602. A faucet 606 is also mounted to the counter cop 602. The main dispenser components 630, i.e. the container, pump, container, the pump and other selected electronics are also located below the counter. Located within dispensing spout 610 is a remote foaming member (not shown) that is substantially the same as remote foaming member 230.

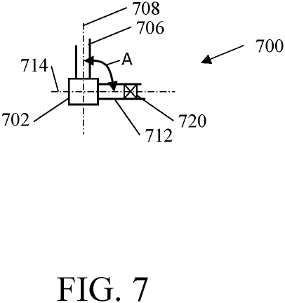

FIG. 7 illustrates exemplary embodiments of a remote mixing chamber 702 having an air inlet 708 and a liquid inlet 712. A one-way liquid inlet valve 720 is located in the liquid fluid flow path. Air inlet conduit 706 has an air conduit centerline 708. Liquid inlet 720 has a liquid conduit centerline 714. In exemplary embodiments, the angle A between the air inlet conduit and the liquid inlet conduit is less than 90 degrees. In exemplary embodiments, the angle A between the air inlet conduit and the liquid inlet conduit is less than 80 degrees. In exemplary embodiments, the angle A between the air inlet conduit and the liquid inlet conduit is less than 70 degrees. In exemplary embodiments, the angle A between the air inlet conduit and the liquid inlet conduit is less than 60 degrees. In exemplary embodiments, the angle A between the air inlet conduit and the liquid inlet conduit is less than 50 degrees. In exemplary embodiments, the angle A between the air inlet conduit and the liquid inlet conduit is less than 40 degrees. In exemplary embodiments, the angle A between the air inlet conduit and the liquid inlet conduit is less than 30 degrees. In exemplary embodiments, the angle A between the air inlet conduit and the liquid inlet conduit is less than 20 degrees. In exemplary embodiments, the angle A between the air inlet conduit and the liquid inlet conduit is less than 10 degrees. In exemplary embodiments, the angle A between the air inlet conduit and the liquid inlet conduit is 0. In exemplary embodiments, the angle A between the air inlet conduit and the liquid inlet conduit is between about 0 degrees and 90 degrees. In exemplary embodiments, the angle A between the air inlet conduit and the liquid inlet conduit is between about 10 degrees and 90 degrees. In exemplary embodiments, the angle A between the air inlet conduit and the liquid inlet conduit is between about 20 degrees and 90 degrees. In exemplary embodiments, the angle A between the air inlet conduit and the liquid inlet conduit is between about 30 degrees and 90 degrees. In exemplary embodiments, the angle A between the air inlet conduit and the liquid inlet conduit is between about 40 degrees and 90 degrees. In exemplary embodiments, the angle A between the air inlet conduit and the liquid inlet conduit is between about 50 degrees and 90 degrees.

While the present invention has been illustrated by the description of embodiments thereof and while the embodiments have been described in considerable detail, it is not the intention of the applicants to restrict or in any way limit the scope of the appended claims to such detail. Additional advantages and modifications will readily appear to those skilled in the art. Moreover, elements described with one embodiment may be readily adapted for use with other embodiments. Therefore, the invention, in its broader aspects, is not limited to the specific details, the representative apparatus and illustrative examples shown and described. Accordingly, departures may be made from such details without departing from the spirit or scope of the applicants’ general inventive concept.

1. A foam-at-a-distance soap or sanitizer dispenser comprising:
a housing;
a container for holding a foamable liquid;
a pump in fluid communication with the container;
the pump having
an air pump chamber;
an air pump chamber air inlet;
an air pump chamber air inlet valve;
an air pump chamber air outlet;
an air pump chamber air outlet valve;
a liquid pump chamber;
a liquid pump chamber liquid inlet;
a liquid pump chamber liquid inlet valve;
a liquid pump chamber liquid outlet; and
a liquid pump chamber liquid outlet valve; and
an air conduit;
the air conduit extending from the air pump chamber air outlet to a remote mixing chamber;
a liquid conduit;
the liquid conduit extending from the liquid pump chamber liquid outlet to the remote mixing chamber;
wherein the remote mixing chamber is located at a distance from the air pump chamber air outlet and the liquid pump chamber liquid outlet and wherein the distance is greater than about 3 inches;
a one-way liquid check valve located proximate the remote mixing chamber; and
an outlet nozzle located proximate the remote mixing chamber.

2. The foam-at-a-distance soap or sanitizer dispenser of claim 1 wherein the one-way liquid check valve is located less than about one inch from the mixing chamber.

3. The foam-at-a-distance soap or sanitizer dispenser of claim 1 further comprising a mixing chamber housing, wherein the mixing chamber housing has a mixing chamber air inlet and a mixing chamber liquid inlet, and wherein the one-way liquid check valve is located at least partially in the mixing chamber liquid inlet.

4. The foam-at-a-distance soap or sanitizer dispenser of claim 3 further comprising a mixing chamber housing, wherein the mixing chamber housing has a mixing chamber air inlet and a mixing chamber liquid inlet wherein a centerline of the mixing chamber liquid inlet and a centerline of the mixing chamber air inlet are perpendicular to one another.

5. The foam-at-a-distance soap or sanitizer dispenser of claim 4 wherein a centerline of the mixing chamber air inlet and a centerline of the mixing chamber fluid inlet intersect at an angle that is between about 45 degrees and about 90 degrees.

6. The foam-at-a-distance soap or sanitizer dispenser of claim 4 wherein a centerline of the mixing chamber air inlet and a centerline of the mixing chamber fluid inlet intersect at an angle that is between about 75 degrees and about 90 degrees.

7. The foam-at-a-distance soap or sanitizer dispenser of claim 1 wherein the pump is located below the reservoir.

8. The foam-at-a-distance soap or sanitizer dispenser of claim 1 wherein the pump and reservoir are located below a counter top and wherein the outlet nozzle and mixing chamber are located above a counter top.

9. The foam-at-a-distance soap or sanitizer dispenser of claim 1 wherein the housing comprises a base and wherein the base is configured to sit on a counter top during use.

10. A foam-at-a-distance counter mount soap or sanitizer dispenser comprising:
a spout configured to be mounted above a counter top;
an outlet nozzle located in the spout;
a mixing chamber located in the spout proximate the outlet nozzle;
a mixing chamber air inlet;
a mixing chamber liquid inlet;
a one-way liquid inlet valve located upstream of and proximate to the mixing chamber liquid inlet;
a pump configured to be located below a counter top;
a liquid pump chamber having a liquid outlet;
one or more air pump chambers having an air outlet;
an air conduit extending from the air outlet to the mixing chamber;
a liquid conduit extending from liquid outlet to the mixing chamber;
wherein the one-way valve is located in the liquid flow path proximate the mixing chamber;
a reservoir configured to be located below the counter top; and
a liquid inlet conduit extending from the reservoir to the pump liquid inlet.

11. The foam-at-a-distance counter mount soap or sanitizer dispenser of claim 10 wherein the air flow path from the air outlet to the mixing chamber includes a one-way air inlet valve.

12. The foam-at-a-distance counter mount soap or sanitizer dispenser of claim 10 wherein the reservoir is located above the pump.

13. The foam-at-a-distance counter mount soap or sanitizer dispenser of claim 10 wherein the reservoir is located below the pump.

14. The foam-at-a-distance counter mount soap or sanitizer dispenser of claim 10 wherein the pump is a multi-diaphragm pump and wherein one diaphragm pumps liquid and two or more diaphragms pump air.

15. The foam-at-a-distance counter mount soap or sanitizer dispenser of claim 10 wherein the one-way liquid inlet valve is less than about an inch from the mixing chamber.

16. A foam-at-a-distance table top soap or sanitizer dispenser comprising:
a base;
a housing extending upward from the base;
pump located in base
the housing having a cantilevered portion extending outward the upward extending housing;
an outlet nozzle located in the cantilevered portion of the housing;
a removable and replaceable reservoir carried by the housing;
a remote mixing chamber located by the outlet nozzle;
wherein the remote mixing chamber is located at least 3 inches from the pump;
the mixing chamber having an air inlet, a liquid inlet and a fluid outlet;
a one-way liquid inlet valve located proximate the liquid inlet;
an air conduit extending from the pump to the mixing chamber air inlet;
a liquid conduit extending from the pump to the liquid inlet, wherein the one-way liquid inlet valve is located in a liquid flow path from the pump to the mixing chamber liquid inlet; and
wherein a centerline of the air inlet and a centerline of the liquid inlet are at an angle of less than 90 degrees with respect to one another.

17. The foam at a distance table top soap or sanitizer dispenser of claim 16 further comprising a mixing chamber housing.

18. The foam at a distance table top soap or sanitizer dispenser of claim 17 wherein the one-way liquid inlet valve is located within the mixing chamber housing.

19. The foam at a distance table top soap or sanitizer dispenser of claim 17 wherein the centerline of the liquid inlet and the centerline of the air inlet intersect at an angle of less than 30 degrees.

20. The foam at a distance table top soap or sanitizer dispenser of claim 17 wherein the centerline of the liquid inlet and the centerline of the air inlet are parallel.
